(19) United States
(12) Patent Application Publication
(10) Pub. No.: US 2024/0192318 A1
(43) Pub. Date: Jun. 13, 2024

(54) METHOD AND APPARATUS WITH RF SIGNAL-BASED MULTI-PERSON POSE ESTIMATION

(71) Applicant: Research & Business Foundation Sungkyunkwan University, Suwon-si (KR)

(72) Inventor: Yu Sung Kim, Suwon-si (KR)

(73) Assignee: Research & Business Foundation Sungkyunkwan University, Suwon-si (KR)

(21) Appl. No.: 18/533,632

(22) Filed: Dec. 8, 2023

(30) Foreign Application Priority Data
Dec. 9, 2022 (KR) 10-2022-0171287

(51) Int. Cl. G01S 7/41; G01S 13/89

(52) U.S. Cl. CPC G01S 7/411; G01S 7/417; G01S 13/89

(57) ABSTRACT

A processor-implemented method including identifying, from received Radio Frequency (RF) signals, a signal feature map, the signal feature map containing information calculated to detect a presence of a person, identifying, from the received RF signals, visual clues according to association information between first information based on a result of image-based Multi-Person Pose Estimation (MPPE) learning and second information based on a result of RF signal-based Multi-Person Pose Estimation (MPPE) learning, detecting one or more persons by utilizing the signal feature map and the visual clues, and detecting one or more poses of the one more persons based on the signal feature map and the visual clues.

### CROSS-REFERENCE TO RELATED APPLICATIONS

The present application claims the benefit under 35 USC § 119 (a) of Korean Patent Application No. 10-2022-0171287 filed in the Korean Intellectual Property Office on Dec. 9, 2022, the entire disclosure of which is incorporated herein by reference for all purposes.

### BACKGROUND OF THE INVENTION

### 1. Field of the Invention

The present invention relates to a method and apparatus with RF signal-based multi-person pose estimation using visual clues.

### 2. Background of the Related Art

The content described in this section simply provides background information about the present invention and does not constitute the prior art.

Multi-Person Pose Estimation (MPPE) is an area of interest in the field of analyzing video information based on deep learning. Within the field of analyzing video information, multi-person detection and pose estimation based on video information received, for example, from one or more cameras observing an object or persons, may have limitations when the field of view of a particular camera is physically blocked or in an instance in which the field of view is hindered due to dark, or poor, lighting conditions.

Recently, multi-person pose estimation based on RF signals (hereinafter, referred to as an RF signal-based method) has an advantage in that it can be used even in an environment where there are obstacles such as walls, i.e., in a situation that does not guarantee visibility. That is, RF signal-based method may not be affected by the level of brightness available to a camera as this method uses transmitted and received RF signals. In addition, in situations where continuous detection of behavioral abnormalities is required, and where there are concerns about protecting personal information, such as in a nursing home where elderly people may live, multi-person pose estimation based on cameras (hereinafter, referred to as a camera-based method) may be preferred.

Meanwhile, although conventional RF signal-based multi-person pose estimation may also use images (or RGB images) captured by a camera, it may be affected by performance of hardware of the camera or the quality and amount of image data for learning. For example, although the performance of multi-person pose estimation can be improved when there are a lot of clear and high-definition images, when these high-quality images may not be available, such as when the visibility is not guaranteed or when the amount of image data is small, it may be difficult to guarantee the performance of multi-person pose estimation. In addition, conventional RF signal-based multi-person pose estimation may require separate hardware devices, such as radar for receiving RF signals. In another example, conventional RF signal-based multi-person pose estimate may require strategically arranged antennas for transmitting and receiving RF signals. Thus, there are limitations in the art due to assumptions about inconveniences and thresholds that require post-processing or pre-processing such as region of interest (ROI) cropping, Non-Maximum Suppression (NMS), keypoint grouping, or the like for learning RF signals.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including identifying, from received Radio Frequency (RF) signals, a signal feature map, the signal feature map containing information calculated to detect a presence of a person, identifying, from the received RF signals, visual clues according to association information between first information based on a result of image-based Multi-Person Pose Estimation (MPPE) learning and second information based on a result of RF signal-based Multi-Person Pose Estimation (MPPE) learning, detecting one or more persons by utilizing the signal feature map and the visual clues, and detecting one or more poses of the one more persons based on the signal feature map and the visual clues.

The method may also include learning the visual clues in a supervised manner to mimic the image feature map extracted on a basis of images generated at a same time as a reception of the RF signals.

The detecting of the one persons may include identifying an integrated feature map of the signal feature map and identifying a feature map of the visual clues.

In a general aspect, here is provided an electronic apparatus including one or more processors configured to execute instructions and a memory storing the instructions, the execution of the instructions configures the one or more processors to identify a signal feature map on a basis of received RF signals, the signal feature map containing information calculated to detect a pose of one or more persons, identify, from the received RF signals, visual clues according to association information between first information based on a result of image-based Multi-Person Pose Estimation (MPPE) learning and second information based on a result of RF signal-based Multi-Person Pose Estimation (MPPE) learning, and estimate poses of one or more detected persons by utilizing the signal feature map and the visual clues.

The processors may be configured to train the apparatus to learn the visual clues in a supervised manner to mimic the image feature map extracted on a basis of images generated at a same time as the receiving of the RF signals.

The processors may be configured to identify an integrated feature map of the signal feature map and identify a feature map of the visual clues.

### BRIEF DESCRIPTION OF THE DRAWINGS

FIG. 1 illustrates an example RF signal-based multi-person pose estimation method using visual clues according to one or more embodiments.

FIG. 2 illustrates an example RF signal-based multi-person pose estimation apparatus using visual clues according to one or more embodiments.

FIG. 3 illustrates examples of visual clues according to cross-modal supervised learning according to one or more embodiments.

FIG. 4 illustrates an example view for explaining a structure for cross-modal supervised learning of visual clues according to one or more embodiments.

FIG. 5 illustrates an example electronic system according to one or more embodiments.

FIG. 6 illustrates an example operation of the electronic system according to one or more embodiments.

FIGS. 7 to 9 illustrate examples of an RF signal-based multi-person pose estimation apparatus using visual clues according to one or more embodiments.

FIG. 10 illustrates an example RF signal-based multi-person pose estimation apparatus using visual clues in an invisible environment according to one or more embodiments.

FIG. 11 illustrates an example electronic device (or system) with RF signal-based multi-person pose estimation using visual clues, in accordance with one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The core of deep learning, which has developed AI technology, is to effectively perform complicated calculations by learning high-level abstract knowledges from data using deep neural networks. Data-based AI models acquire the knowledge needed for performing a task from data. In order to perform a new task, data for learning the new task has be acquired, and the demand for such data may be large depending on the new task. That is, when deep learning is provided with large-scale data, the neural network's knowledge can be learned more effectively, and thus the deep learning performance is improved by analyzing larger amounts of data. However, acquiring a large-volume of data for learning may be costly and require a long period of time secure that data. Accordingly, feature vectors or feature maps of a model trained through large-scale datasets (which may be referred to as a pre-learned model or pre-trained model) and a knowledge distillation technique that can be recalibrated to be suitable for a new model using the feature vectors have been proposed. Through examples of the knowledge distillation technique, a deep learning model may be trained to be applied to a new model even in a situation where only a relatively small amount of data is secured. In a method of transferring knowledge between a model trained through large-scale datasets and a new model that receives knowledges distilled from the model, loss functions such as cross entropy and Kullback-Leibler divergence (KLD) can be used.

In an example, a model trained through large-scale datasets (or may be referred to as a pre-learned model or pre-trained model) may be referred to as a teacher model or a teacher network, and the student model or student network may utilize all or part of the feature extractor or classifier of the teacher model through a soft target. The soft target may use the output of the softmax function as the final output of the model, and may reduce loss of information by obtaining probability information for all categories (or classes).

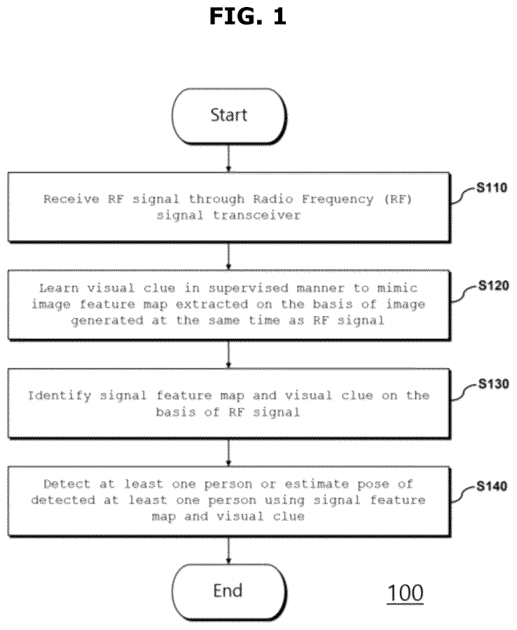

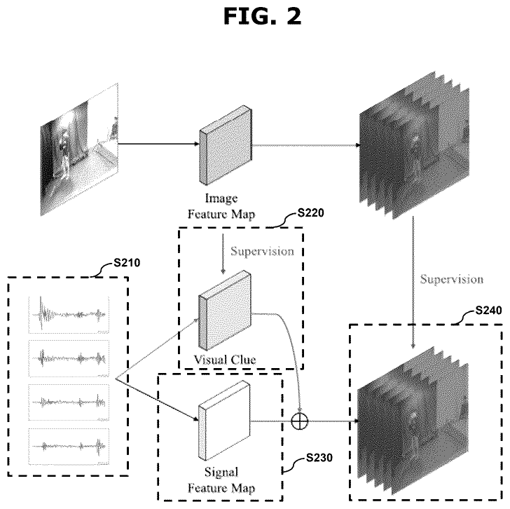

FIG. 1 is an example RF signal-based multi-person pose estimation method using visual clues according to one or more embodiments, and FIG. 2 is an example RF signal-based multi-person pose estimation apparatus using visual clues according to one or more embodiments.

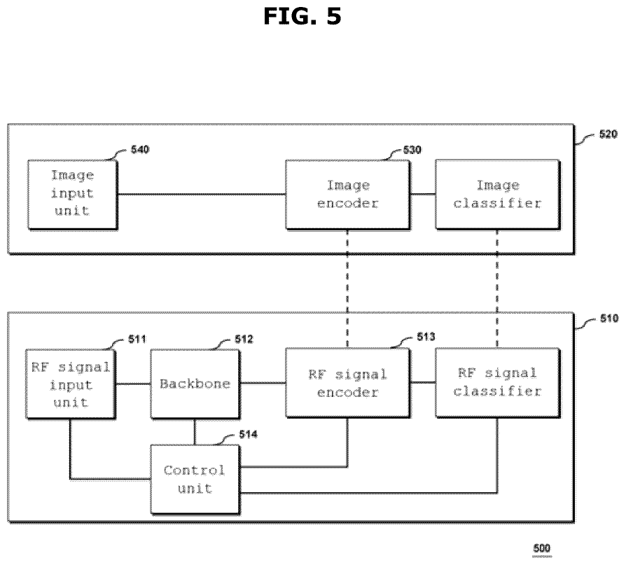

Referring to FIGS. 1 and 2, in a non-limiting example, an electronic apparatus, such as the electronic apparatus 510 of FIG. 5 discussed in greater detail below (i.e., a RF signal-based multi-person pose estimation apparatus using visual clues) may receive RF signals through an RF signal transceiver (S110, S210). In addition, method 100 of FIG. 1 may provide a processor implemented to perform the multi-person pose estimation method.

In an example, the visual clues (VCs) may be learned to mimic an image-based feature map (i.e., an image feature map that was expressed in a camera-based method) and may be generated on the basis of RF signals rather than images, such as video images received through imaging devices and cameras. The electronic apparatus 510 may identify visual clues and a feature map of the visual clues on the basis of the received RF signals. Visual clues may be extracted from RF signals that have the characteristics of being reflected and refracted. Because these visual clues may be extracted from RF signals, rather than relying on images that were captured by a camera, examples of the electronic apparatus 510 and the multi-person pose estimation method (i.e., method 100 of FIG. 1) may be used in disaster relief scenarios such as fire or military or security situations where visibility is not guaranteed. In another example, the multi-person pose estimation method may be able to detect persons and estimate poses regardless of the presence of obstacles.

In an example, although the electronic apparatus 510 may include a Radio Frequency (RF) signal transceiver which may be received through an RF signal input (i.e., RF signal input 511 of FIG. 5), RF signals may also be received from an external RF signal transceiver. The RF signal transceiver may transmit RF signals and may receive RF signals having physical characteristics that have been changed when the transmitted RF signals pass through or are reflected from a specific space or a person located in a specific space. The RF signal transceiver may transmit and receive RF signals according to commercial RF communication technologies, such as ultra-wideband (UWB), Wi-Fi communication, and the like, and may include Multiple Input Multiple Output (MIMO) antennas in addition to UWB communication antennas or Wi-Fi antennas. The RF signals are radio frequency signals, and electromagnetic waves corresponding to radio frequencies may generally include radio waves used for broadcasting and signals used as alternating current frequencies for transmitting and receiving signals of various wireless communications.

In an example, the electronic apparatus 510 may learn the visual clues in a supervised manner to mimic the image feature map extracted on the basis of images (RGB images) generated at the same time as the RF signals (S120, S220).

In an example, the electronic apparatus 510 may utilize knowledge distillation techniques and may utilize supervised learning based on a teacher network and a student network. The teacher network may provide cross modal supervision to the student network by utilizing multi-person pose estimation based on, for example, video inputs received from one or more cameras (or images generated by the cameras). Through the cross-modal supervised learning, the student network may learn the learning data according to the teacher network in a state where a label, i.e., an explicit correct answer, is given.

In an example, the electronic apparatus 510 may receive captured images at a same time when the RF signals are received, and may provide a result that includes a detection of persons and an estimation of poses according to a camera-based method as annotations. The student network may receive RF signals and learn a method of predicting annotations about detecting persons and estimating poses provided by the teacher network. In an example, the annotation may include at least any one among the data types such as a bounding box that displays a rectangular frame aligned with the edges of an object in an image and distinguishes classes of corresponding objects, a point that marks an object to be searched from an image by putting a dot on the object, and a keypoint that identifies the outlines of an object to be detected which may include polygons and points to identify the shape of the object, a polyline, a polygon, and the like, although examples are not limited thereto.

In an example, the electronic apparatus 510 may input images generated when the RF signals are received into a camera-based method to provide information on regions of individual persons, locations of individual key body parts, and image feature map information as ground-truth. In other words, the RF signal transceiver may be synchronized with the camera, generate images by the camera, simultaneously receive RF signals corresponding to the generated images, and use a result of the camera-based multi-person pose estimation (e.g., the number of persons, the respective poses of each person) as an annotation about detecting persons and estimating poses on the basis of the RF signals. Thereafter, the electronic apparatus 510 may learn the result of multi-person pose estimation based on the RF signals, i.e., perform cross-modal supervised learning. It is possible to indicate the original or real value of data desired to learn the ground-truth, and indicate a preset correct answer or an answer that may be desired to be predicted as an answer by the model.

The electronic apparatus 510 may learn the visual clues to mimic the image feature map on the basis of a transformer, and may be trained to estimate information on regions of individual persons and locations of individual key body parts using the visual clues and RF signals.

In an example, the electronic apparatus 510 may identify a signal feature map and visual clues on the basis of the RF signals (S130, S230).

In an example, the signal feature map may be defined as essential information calculated to detect persons or estimate poses on the basis of the RF signals. The performance of the RF signal-based multi-person detection and an accuracy of the pose estimation may be improved by performing supervised learning to mimic visual clues which may only be capable of being obtained from the camera-based method.

In an example, the electronic apparatus 510 may detect one or more persons or estimate respective poses of the detected persons by utilizing the signal feature map and the visual clues (S140, S240).

In an example, the electronic apparatus 510 may extract key information needed for estimating, for example, the presence of and the respective poses for one or more persons within detectable range of the RF signals from raw data acquired from the RF signals, i.e., original signal data, through the deep learning technique without a complicated preprocessing process. Therefore, human intervention may not be required as learning may be performed in a fully end-to-end manner. In addition, as the electronic apparatus 510 learns the visual clues, it may improve accuracy of detecting persons and estimating poses by being able to better understand RF signal patterns and generating further better RF feature representations.

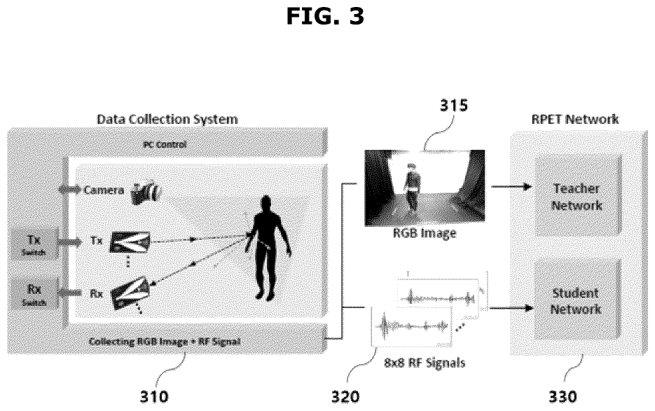

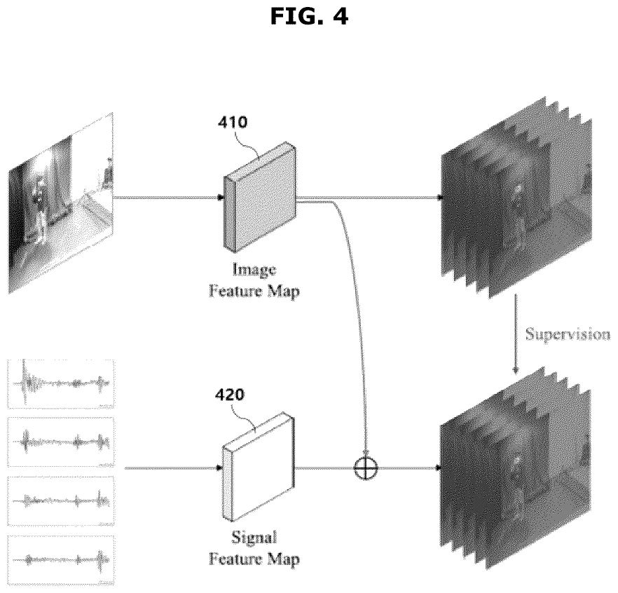

FIG. 3 illustrates examples of visual clues according to cross-modal supervised learning according to one or more embodiments, and FIG. 4 illustrates an example structure for cross-modal supervised learning of visual clues according to one or more embodiments.

Referring to FIGS. 3 and 4, in a non-limiting example, end-to-end learning may be performed for cross-modal supervised learning, in which RGB images are trained by a teacher network and RF signals are trained by a student network. In an example, the camera (i.e., the image input unit 540 of FIG. 5 described in greater detail below) and the RF transceiver (i.e., RF signal input unit 511) of a data collection system 310 may be synchronized to generate RGB images 315 generated upon receiving the RF signals 320. The RPET network 330 of the electronic apparatus 510 may learn the visual clues on the basis of the RF signals and learn to estimate information on the regions of individual persons and locations of individual key body parts using the visual clues and the RF signals. A camera-based multi-person pose estimation model may extract information on the bounding box and information on the key body parts (keypoints) of each person, and RF signals may be input and learned to match the extracted ground-truth information.

In an example, referring to FIG. 4, the electronic apparatus 510 may receive an image feature map 410 extracted on the basis of the images (i.e., images 315 of FIG. 3) and a signal feature map 420 extracted on the basis of the RF signals (i.e., RF signals 320 of FIG. 3).

In an example, the encoder of the teacher network (or may be referred to as an encoder neural network) receiving an RGB image may generate an image feature map, and the image feature map may be referred to as a result obtained through a convolution operation from the pixel information of the RGB image to extract the features of the input RGB image, and may be expressed as, for example, a 768×256 matrix or the like.

In an example, the image feature map may be input into a decoder (or may be referred to as a decoder neural network) and restored in an RGB image size, and may be displayed to include the locations of multiple persons and information on locations of key body parts for those persons. The image feature map restored through the encoding and decoding may be understood as a map generated by removing information on the surrounding objects, walls, and the like, and extracting feature points that can predict the locations of the detected persons and information on the key body parts.

In an example, the teacher network may include a backbone network to extract features of the RGB image, and utilize additional positional encoding to contain relative position information of each RGB image. Respective pixel information may be classified as sequential data and may include a transformer architecture for sequential data processing, and the data may be configured from an image feature map having a specific dimension. Thereafter, the data may be queried and classified to inform the class of each object and the location of the bounding box indicating a position of the object.

In an example, the encoder of the student network that receives RF signals may generate a signal feature map through 1D Convolutional Neural Networks (1D CNN). The generated signal feature map may be learned for multi-person pose estimation through the decoder.

In an example, the electronic apparatus 510 that receives RF signals may generate visual clues and a signal feature map, and may detect one or more persons and likewise estimate respective poses for those persons using the visual clues and the signal feature map as input information.

In an embodiment, on the basis of the RF signals, the visual clue may be defined as association information between information on the result of image-based Multi-Person Pose Estimation (MPPE) learning and information on the result of RF signal-based Multi-Person Pose Estimation (MPPE) learning. The visual clue may minimize, for example, the mean square error (MSE) function to mimic the image feature map extracted by the encoder of the image-based model, and at the same time, may be attached to the signal feature map to be used as an input of the decoder. Thereafter, the electronic apparatus 510 may be trained to infer information on the bounding box and information on key body parts of each person using a transformer method through the decoder.

The RF signal-based multi-person pose estimation method using visual clues according to an embodiment may include general knowledge distillation methods and may have a structure of a teacher network and a student network. The electronic apparatus 510 may include a pre-learning classifier that functions as a teacher network and a fine-tuning classifier that functions as a student network. In an example, the pre-learning classifier (or may be referred to as a deepest classifier) may include at least one resNet block and a softmax function block, and the fine-tuning classifier (or may be referred to as a shallow classifier) may include at least one fully connected layer (FC layer) and a softmax function block. According to embodiments, the RF signal-based multi-person pose estimation method using visual clues may be performed by a previously trained classifier (or may also be referred to as a pre-trained classifier, a pre-trained model, or a pre-trained network) and the fine-tuning classifier.

In an example, although the pre-learning classifier and the fine-tuning classifier may include a feature extractor capable of extracting features of input data and a classifier for calculating the output value of the feature extractor as a probability, the same output value may be received from the feature extractor configured to be separated from the pre-learning classifier and the fine-tuning classifier.

In an example, the receiving of the same output value from the feature extractor configured to be separated from the pre-learning classifier and the fine-tuning classifier may be understood as using the same input data, and it may be understood that knowledges are distilled or transferred between the pre-learning classifier and the fine-tuning classifier on the basis of the same input. This is because the fine-tuning classifier may use a label value (label information) of the pre-learning classifier and a soft target previously derived by the pre-learning classifier.

In an example, the feature extractor may be configured to include at least one convolution layer and a pooling layer, and the feature extractor may be pretrained on the basis of input data that may already be provided in advance, and the output value of the feature extractor may be referred to as a bottleneck or a feature vector.

In an example, each of the pre-learning classifier and the fine-tuning classifier may calculate the output value of the feature extractor as a probability value on the basis of each softmax function, and classify the output value into at least two categories (or classes).

In an example, the pre-learning classifier and the fine-tuning classifier may be connected through a fully connected layer and configured to include one or more dense layers (or may be referred to as a dense layer), and to reduce an overfitting as a dropout layer and a batch normalization layer are placed between the one or more dense layers.

In an example, the fine-tuning classifier may adjust the weight of the softmax function applied to the pre-learning classifier, analyze the type and total amount of data, and retrain some of the weights of the pre-learning classifier or relearn all the weights from the start on a basis of the type and total amount of data.

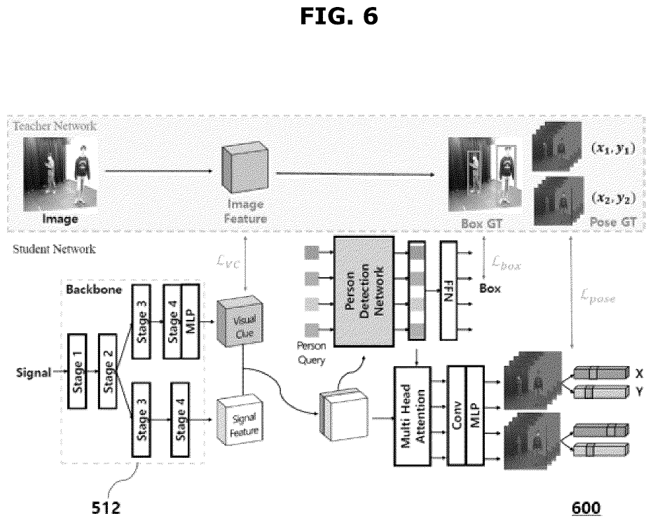

FIG. 5 illustrates an example electronic system according to one or more embodiments, and FIG. 6 illustrates an example operation of the electronic system according to one or more embodiments.

Referring to FIGS. 5 and 6, in a non-limiting example, electronic system 500 may include an electronic apparatus 510 (i.e., an RF signal-based multi-person pose estimation apparatus that may employ visual clues). In an example, the electronic system 500 may include an RF signal input unit 511 for receiving RF signals through an RF signal transceiver as an input data, a backbone (or backbone network) 512 for transforming raw data of the RF signals into a signal feature map, a transformer (not shown) for transforming sequence data into data having a preset dimension, an RF signal encoder 513 for extracting a signal feature map or visual clues, a classifier 514 capable of classifying data to inform the class of a person (object) and the location of a bounding box where the person exists through a query or the like, and a control unit 515 configured to control an overall operation of the electronic system 500, including the electronic apparatus 510, where the control unit 515 is configured to detect persons through a Person Detection Network (PDN) (as illustrated in the electronic system 600 of FIG. 6) that identifies the bounding box of a person, and calculates a result of pose estimation by including a pose estimator that predicts keypoints in the body of each person. In an example, the electronic apparatus 510 may include a student network without including a teacher network 520.

In an example, referring to FIG. 6, in the electronic system 600, information from the image feature map and learning results may be transmitted from an external teacher network to the student network.

In an example, referring back to FIG. 5, the RF signal encoder 513 may extract a feature map integrating the signal feature map and the visual clues on the basis of the RF signals. Referring to FIG. 6, the backbone 512 may be divided into two branches, and one branch may indicate the signal feature map, and the other branch may indicate the feature map of the visual clues. The feature map of the visual clues may be trained to mimic the image feature map obtained from the teacher network, and, in addition, regularization methods may be applied to the backbone 512 to enhance learning efficiency.

In an example, the PDN may create or design a person detection network based on the object query, and may extract regions representing individual persons from the integrated feature map of the signal feature map and the feature map of the visual clues, including information on all persons represented by the encoder 513 of FIG. 5. In a non-limiting example, the PDN may perform multi-head attention between the integrated feature map and the object query, and estimate a bounding box through a Feed Forward Network (FFN). The object query, which is the output of the PDN, may include information on the detected persons, and the pose estimator may estimate poses of each detected person using the output of the PDN. The pose estimator may calculate a multi-head attention score between the query and the integrated feature map of the encoder, and then generate a number of attention heatmap that matches a number of queries for the persons, and the respective attention heat maps may be input into convolution layers and a multi-layer perceptron (MLP), and finally, prediction of the x and y coordinates of each detected keypoint of a human body may be output.

In an example, a keypoint heatmap representing the coordinates of each body joint and their x and y coordinates in the Gaussian distribution may be used in the pose estimation. The pose estimator may predict and compare a keypoint heatmap with real ones, and heatmap-based pose estimation may require a post-processing process of estimating final joint coordinates on the basis of the maximum value of the keypoint heatmap.

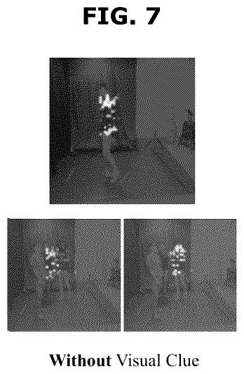

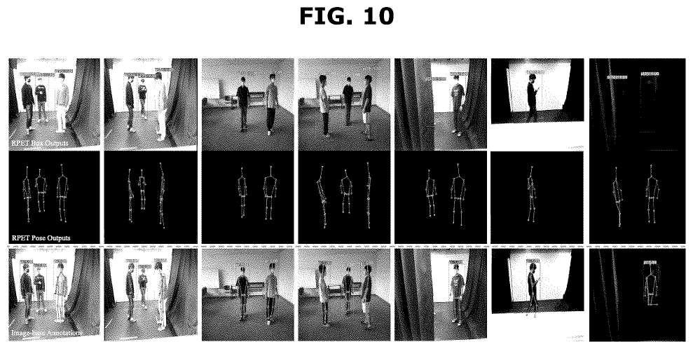

FIGS. 7 to 9 illustrates examples effects of an RF signal-based multi-person pose estimation apparatus using visual clues according to one or more embodiments, and FIG. 10 illustrates examples of an RF signal-based multi-person pose estimation apparatus using visual clues in an invisible environment according to one or more embodiments.

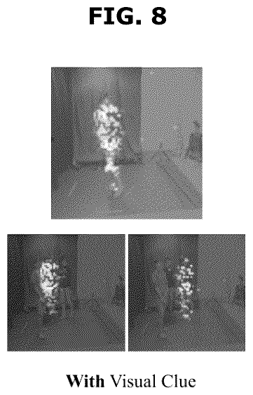

Referring to FIGS. 7 and 8, in a non-limiting example, keypoint heatmaps illustrate a same sample in a first case without visual clues (i.e., FIG. 7) and in a second case with visual clues (i.e., FIG. 8), and it may be understood that the heatmap of a model with visual clues may better identify a human body.

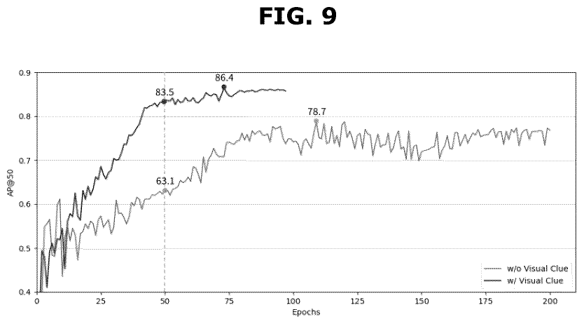

Referring to FIG. 9, the convergence curve of a test set in bounding box AP@50 when visual clues are applied illustrates that an accuracy of detecting persons may be enhanced, providing a shorter learning time with the help of visual clues.

Referring to FIG. 10, when compared with the camera-based method, the performance of detecting persons and estimating poses using visual clues is illustrated as being effective even in a test that includes various scenarios in untrained, occluded, and dark environments.

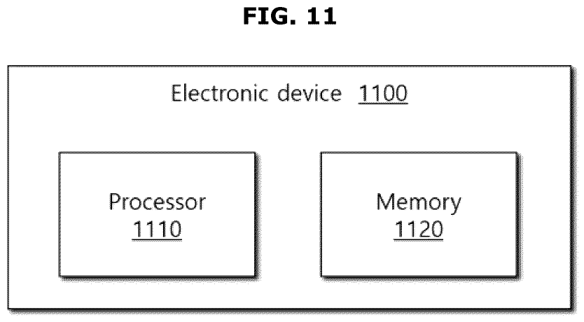

FIG. 11 illustrates an example electronic device (or system) with RF signal-based multi-person pose estimation using visual clues according to one or more embodiments.

Referring to FIG. 11, an electronic device 1100 may include at least one processor 1110 and a memory 1120. The description provided with reference to FIGS. 1 to 6 above may also be applied to FIG. 11.

The processor 1110 may be configured to execute computer-readable instructions to configure the processor 1110 to control the electronic device 1100 to perform one or more or all operations and/or methods represented by the method of FIG. 1, and/or as described above in the arrangements described by the systems and apparatuses of FIGS. 2-6, and may include any one or a combination of two or more of, for example, a central processing unit (CPU), a graphic processing unit (GPU), and a neural processing unit (NPU), but is not limited to the above-described examples. The processor 1110 may also execute programs or applications to control other functionalities of the electronic device.

The memory 1120 may store computer-readable instructions. The processor 1110 may be configured to execute computer-readable instructions, such as those stored in the memory 1120, and through execution of the computer-readable instructions, the processor 1110 is configured to perform one or more, or any combination, of the operations and/or methods described herein.

The memory 1120 may be a volatile or nonvolatile memory. The memory 1120 may include, for example, random-access memory (RAM), dynamic random-access memory (DRAM), static random-access memory (SRAM), or other types of non-volatile memory known in the art.

The electronic system 500, electronic system 600, electronic apparatus, processor 1110, memory 1120, RF signal input 511, image input unit 540, image encoder 530, teacher network 520, student network 510, backbone 512, RF signal encoder 513, and control unit 514 described herein and disclosed herein described with respect to FIGS. 1-6 and 11 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
identifying, from received Radio Frequency (RF) signals, a signal feature map, the signal feature map containing information calculated to detect a presence of a person;
identifying, from the received RF signals, visual clues according to association information between first information based on a result of image-based Multi-Person Pose Estimation (MPPE) learning and second information based on a result of RF signal-based Multi-Person Pose Estimation (MPPE) learning;
detecting one or more persons by utilizing the signal feature map and the visual clues; and
detecting one or more poses of the one more persons based on the signal feature map and the visual clues.

2. The method according to claim 1, further comprising learning the visual clues in a supervised manner to mimic an image feature map extracted on a basis of images generated at a same time as a reception of the RF signals.

3. The method according to claim 1, wherein the detecting of the one or more persons comprises:
identifying an integrated feature map of the signal feature map; and
identifying a feature map of the visual clues.

4. An electronic apparatus, the apparatus comprising:
one or more processors configured to execute instructions; and
a memory storing the instructions, wherein execution of the instructions configures the one or more processors to:
identify a signal feature map on a basis of received RF signals, the signal feature map containing information calculated to detect a pose of one or more persons;
identify, from the received RF signals, visual clues according to association information between first information based on a result of image-based Multi-Person Pose Estimation (MPPE) learning and second information based on a result of RF signal-based Multi-Person Pose Estimation (MPPE) learning; and
estimate poses of one or more detected persons by utilizing the signal feature map and the visual clues.

5. The apparatus according to claim 4, wherein the processors are configured to:
train the apparatus to learn the visual clues in a supervised manner to mimic an image feature map extracted on a basis of images generated at a same time as the receiving of the RF signals.

6. The apparatus according to claim 4, wherein the processors are further configured to:
identify an integrated feature map of the signal feature map; and
identify a feature map of the visual clues.
